(19) United States
(12) Patent Application Publication
(10) Pub. No.: US 2022/0392192 A1
(43) Pub. Date: Dec. 8, 2022

(54) TARGET RE-RECOGNITION METHOD, DEVICE AND ELECTRONIC DEVICE

(71) Applicant: Beijing Baidu Netcom Science Technology Co., Ltd., Beijing (CN)

(72) Inventors: Zhigang Wang, Beijing (CN); Jian Wang, Beijing (CN); Hao Sun, Beijing (CN)

(73) Assignee: Beijing Baidu Netcom Science Technology Co., Ltd., Beijing (CN)

(21) Appl. No.: 17/890,020

(22) Filed: Aug. 17, 2022

(30) Foreign Application Priority Data
Sep. 30, 2021 (CN) 202111160414.7

(51) Int. Cl. G06V 10/74; G06V 10/98; G06V 10/764; G06V 40/50; G06V 10/77

(52) U.S. Cl. CPC G06V 10/761; G06V 10/98; G06V 10/764; G06V 40/50; G06V 10/7715; G06V 2201/07

(57) ABSTRACT

A target re-recognition method, a target re-recognition device and an electronic device are provided, which relate to the field of artificial intelligence, in particularly to the field of computer vision and deep learning. The target re-recognition method includes obtaining a to-be-recognized image, and the to-be-recognized image including image content of a target object; recognizing first appearance presentation information corresponding to the target object, and the first appearance presentation information being configured to represent a presentation form of an appearance of the target object in the to-be-recognized image; obtaining from a data retrieval library a candidate retrieval image matching the first appearance presentation information; and performing target re-recognition on the to-be-recognized image based on the candidate retrieval image.

### CROSS-REFERENCE TO RELATED APPLICATION

The present disclosure claims priority to Chinese Patent Application No. 202111160414.7 filed in China on Sep. 30, 2021, the entire contents of which are hereby incorporated by reference.

### TECHNICAL FIELD

The present disclosure relates to the field of artificial intelligence, in particularly to the field of computer vision and deep learning, and specifically to a target re-recognition method, a target re-recognition device and an electronic device.

### BACKGROUND

With rapid development of artificial intelligence technology, target re-recognition technology, such as pedestrian re-recognition, has been widely used. The target re-recognition technology refers to target re-recognition of image content in a to-be-recognized image based on a retrieval image, so as to determine whether there is a same object in the to-be-recognized image and the retrieval image.

A re-recognition model may be used to perform target re-recognition on the to-be-recognized image, and the re-recognition model is usually used to perform the target re-recognition through comparing features of the retrieval image with features of the to-be-recognized image.

### SUMMARY

An object of the present disclosure is to provide a target re-recognition method, a target re-recognition device and an electronic device.

In one aspect, the present disclosure provides in some embodiments a target re-recognition method, including: obtaining a to-be-recognized image, and the to-be-recognized image including image content of a target object; recognizing first appearance presentation information corresponding to the target object, and the first appearance presentation information being configured to represent a presentation form of an appearance of the target object in the to-be-recognized image; obtaining from a data retrieval library a candidate retrieval image matching the first appearance presentation information; and performing target re-recognition on the to-be-recognized image based on the candidate retrieval image.

In another aspect, the present disclosure provides in some embodiments a target re-recognition device, including: a first obtaining module, configured to obtain a to-be-recognized image, and the to-be-recognized image including image content of a target object; an recognition module, configured to recognize first appearance presentation information corresponding to the target object, and the first appearance presentation information being configured to represent a presentation form of an appearance of the target object in the to-be-recognized image; a second obtaining module, configured to obtain from a data retrieval library a candidate retrieval image matching the first appearance presentation information; and a target re-recognition module, configured to perform target re-recognition on the to-be-recognized image based on the candidate retrieval image.

In yet another aspect, the present disclosure provides in some embodiments an electronic device, including: at least one processor; and a storage communicatively connected to the at least one processor. The storage stores therein an instruction configured to be executed by the at least one processor, and the at least one processor is configured to execute the instruction, to implement the above-mentioned method.

In still yet another aspect, the present disclosure provides in some embodiments a non-transitory computer readable storage medium, storing therein a computer instruction. The computer instruction is configured to be executed by a computer, to implement the above-mentioned method.

In still yet another aspect, the present disclosure provides in some embodiments a computer program product, including a computer program. The computer program is configured to be executed by a processor, to implement the above-mentioned method.

It is understood, this summary is not intended to identify key features or essential features of the embodiments of the present disclosure, nor is it intended to be used to limit the scope of the present disclosure. Other features of the present disclosure will become more comprehensible with reference to the following description.

### BRIEF DESCRIPTION OF THE DRAWINGS

The drawings are merely used to understand the schemes in the embodiments of the present disclosure better, but shall not be construed as limiting the present disclosure. In these drawings,

FIG. 1 is a flow chart of a target re-recognition method according to a first embodiment of the present disclosure;

FIG. 2 is a schematic view showing a storing process of a to-be-stored image;

FIG. 3 is a schematic view showing a target re-recognition device according to a second embodiment of the present disclosure; and

FIG. 4 is a block diagram of an electronic device used to implement the embodiments of the present disclosure.

### DETAILED DESCRIPTION

In the following description, numerous details of the embodiments of the present disclosure, which should be deemed merely as exemplary, are set forth with reference to accompanying drawings to provide a thorough understanding of the embodiments of the present disclosure. Therefore, those skilled in the art will appreciate that modifications or replacements may be made in the described embodiments without departing from the scope and spirit of the present disclosure. Further, for clarity and conciseness, descriptions of known functions and structures are omitted.

### First Embodiment

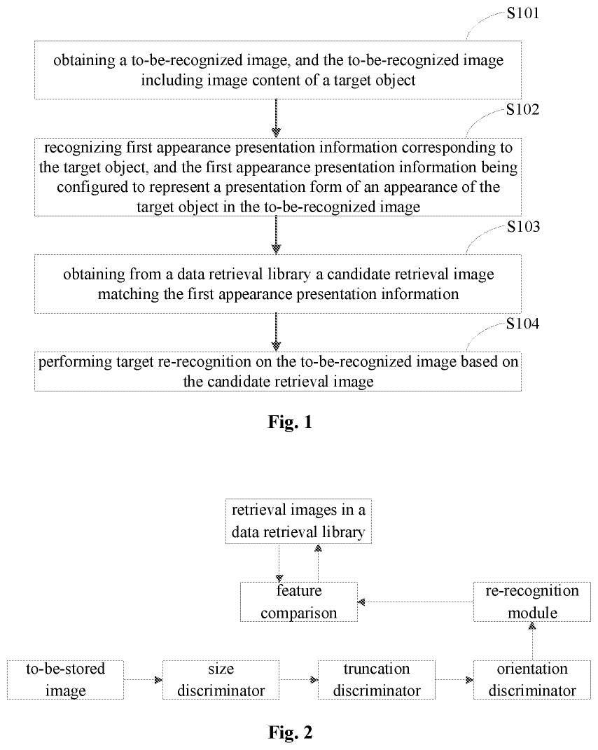

As shown in FIG. 1, the present disclosure provides a target re-recognition method, which includes the following steps.

Step S101: obtaining a to-be-recognized image, and the to-be-recognized image including image content of a target object.

In this embodiment, the target re-recognition method relates to the field of artificial intelligence, in particular to the field of computer vision and deep learning, and may be widely applied to smart cities and smart cloud scenarios. According to the embodiments of the present disclosure, the target re-recognition method may be executed by the target re-recognition device. The target re-recognition device in the embodiments of the present disclosure may be configured in any electronic device to execute the target re-recognition method in the embodiments of the present disclosure. The electronic device may be a server or a terminal, which will not be particularly defined herein.

The to-be-recognized image may be any image including the image content of the target object, and the target object may be a person, an animal or a vehicle, which will not be particularly defined herein.

In an example, the target object is a person, and the to-be-recognized image may include the image content of a human body. In this example, it is to determine a relationship between the human body in the to-be-recognized image and the human body in a retrieval image in a data retrieval library through the target re-recognition, and the relationship is used to represent whether the human body in the to-be-recognized image and the human body in the retrieval image in the data retrieval library are a same person.

The to-be-recognized image may include a part or all of the image content of the target object, e.g., the to-be-recognized image may include image content of an entire human body, may include image content of human torso, or may include image content of upper part of human body. Besides the image content of the target object, the to-be-recognized image may further include other image content, e.g., image content of background and image content of other objects, which will not be particularly defined herein.

The obtaining of the to-be-recognized image may be implemented through various manners, e.g., an image may be captured by a camera in real time as the to-be-recognized image, an image stored in advance may be obtained as the to-be-recognized image, an image transmitted by another electronic device may be received as the to-be-recognized image, or an image may be downloaded from the network as the to-be-recognized image.

In a possible embodiment of the present disclosure, e.g., in smart cities and smart cloud scenarios, cameras may be arranged at various positions to collect pedestrian images, and the pedestrian images are stored in the data retrieval library for corresponding applications. For example, it is able to determine whether there is a target human body in the retrieval image in the data retrieval library through the target re-recognition, or it is able to determine the identity of the pedestrian in a newly shot pedestrian image, and the newly shot pedestrian image is stored in a corresponding position of the data retrieval library in accordance with the identity.

Step S102: recognizing first appearance presentation information corresponding to the target object, and the first appearance presentation information being configured to represent a presentation form of an appearance of the target object in the to-be-recognized image.

In step S102, the first appearance presentation information may represent the presentation form of the appearance of the target object in the to-be-recognized image, and the presentation form may include an appearance presentation size, an appearance truncation position, an appearance presentation truncation ratio, or an appearance presentation posture.

The appearance presentation size may refer to the proportion of the image content of the target object to the to-be-recognized image. If the proportion of the image content of the target object to the to-be-recognized image is small, the appearance presentation size is small.

The appearance presentation truncation ratio refers to the ratio at which the appearance of the target object is truncated outside the to-be-recognized image, i.e., the ratio at which the appearance of the target object is not in the to-be-recognized image. The appearance truncation position refers to a position from which the appearance of the target object may not be presented in the to-be-recognized image.

For example, when the image content of the entire human body is presented in the to-be-recognized image, it indicates that the appearance presentation truncation ratio of the target object is 0; and when merely the image content of the upper part of the human body is presented in the to-be-recognized image, the appearance presentation truncation ratio is 50%, and the appearance truncation position is the leg part.

The appearance presentation posture may refer to the presentation posture of the appearance of the target object in the to-be-recognized image, and in a possible embodiment of the present disclosure, the appearance presentation posture may be an appearance orientation, e.g., the face of the human body is oriented toward front, the face of the human body is oriented toward back, and the face of the human body is oriented toward a side.

Due to the different shooting distance, shooting angles and shooting ranges of the camera and other reasons, the appearance of the object is presented in different forms in the shot image. If the presentations of objects in two images are inconsistent, it is difficult to determine whether the two images have the same object, thereby to adversely affect the accuracy of the target re-recognition.

For example, in two images of a same person, the upper part of the human body in one image is truncated, the lower part of the human body in the other image is truncated, and it is difficult to determine that the two images are the same person through the re-recognition model. In this regard, in step S102, the first appearance presentation information may be recognized to determine the presentation form of the appearance of the target object in the to-be-recognized image.

The first appearance presentation information may be recognized in a plurality of ways. In a possible embodiment of the present disclosure, it is able to detect the first appearance presentation information of the target object in the to-be-recognized image through a known or new target detection algorithm.

In a possible embodiment of the present disclosure, it is able to detect the presentation form of the appearance of the target object in the to-be-recognized image through a discriminator. For example, it is able to determine the appearance presentation size of the target object in the to-be-recognized image through a size discriminator, and the size discriminator may be a logic code for judging in accordance with a size of the image, or may be a model used to accurately judge the size and blur degree of the actual human body in the image.

For example, it is able to determine the appearance truncation position and the appearance presentation truncation ratio of the target object in the to-be-recognized image through a truncation discriminator. The truncation discriminator may be a pre-trained model for judging whether an object in an image is truncated, and judging the truncated position of the appearance and the appearance presentation truncation ratio in response to the object being truncated.

For example, it is able to determine the appearance orientation of the target object in the to-be-recognized image through an orientation discriminator. The orientation discriminator may be a pre-trained model for judging an orientation of an object in an image, e.g., the orientation of the human body, is front, back, or a side.

Step S103: obtaining from a data retrieval library a candidate retrieval image matching the first appearance presentation information.

In step S103, the data retrieval library may refer to a database storing retrieval images, the data retrieval library may store retrieval images including image content of the target, and the image content of the target may refer to image content of the object with known identity, i.e., the identity of the object in the retrieval images in the data retrieval library is known, so as to perform the target re-recognition on the to-be-recognized image based on the retrieval images in the data retrieval library. The known identity of the object in the retrieval images in the data retrieval library may refer to that there is an identifier for the object in the retrieval images.

In this embodiment, it is able to determine whether the object in the to-be-recognized image is the same as the object in the candidate retrieval image through comparing the feature of the to-be-recognized image with the feature of the candidate retrieval image in the data retrieval library. In an implementation scenario, the identity of the object in the to-be-recognized image may be determined, when it is determined that there is no retrieval image having the same identity as an object in a to-be-recognized image in the data retrieval library, a new identifier may be automatically generated, and the to-be-recognized image is stored in the data retrieval library to enrich resources of the data retrieval library; alternatively, when it is determined that a retrieval image with the same identity as the object in the to-be-recognized image exists in the data retrieval library, the to-be-recognized image may further be stored in the data retrieval library in the case that the data retrieval library does not include the to-be-recognized image, so as to enrich the resources of the data retrieval library.

In another implementation scenario, such as a security scenario, it is able to determine whether there is an object with the same identity as the object in the to-be-recognized image in the candidate retrieval image in the data retrieval library, and in the case that the object with the same identity exists, it is able to determine the position of the object in the to-be-recognized image based on shooting position corresponding to the candidate retrieval image, so as to achieve the purpose of searching for a person or an object.

The appearance presentation information of the object in each retrieval image in the data retrieval library may be recognized by a known or new image recognition algorithm, and the appearance presentation information of the object is compared with the first appearance presentation information to obtain the candidate retrieval image matching the first appearance presentation information in the data retrieval library. The candidate retrieval image matching the first appearance presentation information refers to a retrieval image whose appearance presentation information of the object in the data retrieval library is similar or the same as the first appearance presentation information.

The data retrieval library may further store the retrieval images in accordance with the identity of the object and the appearance presentation label, and the appearance presentation label may include an appearance presentation size label, an appearance presentation posture label, an appearance presentation truncation ratio label, an appearance truncation position label.

For example, retrieval images with the same identity may be stored in a folder, or retrieval images corresponding to similar appearance presentation labels may be stored in a folder. In a word, no matter how it is stored, one retrieval image may correspond to at least two kinds of information, which are the identifier and the appearance presentation label, and the corresponding retrieval image may be found in the data retrieval library based on the identifier and/or the appearance presentation label.

Due to inconsistent presentation forms of objects in two images, the accuracy of the target re-recognition may be adversely affected. In this regard, it is able to obtain a candidate retrieval image matching the first appearance presentation information in the data retrieval library, so as to align the two to-be-compared images as much as possible in the presentation form of the image content of the object, thereby to reduce the interference of the presentation form of the image content of the object on the image content itself.

The data retrieval library may include one or more candidate retrieval images matching the first appearance presentation information, and the data retrieval library may include one type or two types of candidate search images in the case that the candidate retrieval images include more than one candidate retrieval image.

A first type of candidate retrieval image may be referred to as a first candidate retrieval image, which indicates a candidate retrieval image corresponding to a first target appearance presentation label, and the first target appearance presentation label refers to an appearance presentation label that is quite similar to the first appearance presentation information, i.e., the similarity between the first target appearance presentation label and the first appearance presentation information is greater than or equal to a sixth predetermined threshold, and the sixth predetermined threshold is generally larger, such as 90%. When it is determined that that there is a retrieval image corresponding to the first target appearance presentation label in the data retrieval library, the retrieval image corresponding to the first target appearance presentation label in the data retrieval library is obtained as the first candidate retrieval image.

A second type of candidate retrieval image may be referred to as a second candidate retrieval image, which indicates a candidate retrieval image corresponding to a second target appearance presentation label, and the second target appearance presentation label refers to an appearance presentation label that is relatively similar to the first appearance presentation information, i.e., the similarity between the second target appearance presentation label and the first appearance presentation information is greater than or equal to the first predetermined threshold and less than the sixth predetermined threshold. The sixth predetermined threshold is greater than the first predetermined threshold, and the first predetermined threshold may not be too small, otherwise, a retrieval image in which the presentation form of the object in the data retrieval library is inconsistent with the presentation form of the object in the to-be-recognized image may be taken as the candidate retrieval image, which adversely affects the accuracy of the target re-recognition. When it is determined that that there is a retrieval image corresponding to the second target appearance presentation label in the data retrieval library, the retrieval image corresponding to the second target appearance presentation label in the data retrieval library is obtained as the second candidate retrieval image.

The similarity between the appearance presentation label and the first appearance presentation information may be determined through calculating a distance between the appearance presentation label and the first appearance presentation information, i.e., the similarity is equal to 1 subtracts the distance.

The distance between the appearance presentation label and the first appearance presentation information may be calculated by a distance formula, to be specific, it is able to calculate a distance between the appearance presentation size and the appearance presentation size label, a distance between the appearance presentation posture and the appearance presentation posture label, a distance between the appearance presentation truncation ratio and the appearance presentation truncation ratio label, and a distance between the appearance truncation position and the appearance truncation position label. A sum of these distances, or an average value of these distances may be determined as the distance between the appearance presentation label and the first appearance presentation information.

Step S104: performing target re-recognition on the to-be-recognized image based on the candidate retrieval image.

In step S104, it is essentially to judge whether the objects in the two images are the same object through comparing the feature similarity between the candidate retrieval image and the to-be-recognized image, and to judge whether the human bodies in the two images are the same person in the case that the object is a person.

To be specific, each of the feature of the candidate retrieval image and the feature of the to-be-recognized image may be extracted through the re-recognition model, and the distance between the feature of the candidate retrieval image and the feature of the to-be-recognized image may be calculated through a known or new distance calculation algorithm, so as to determine the feature similarity between the feature of the candidate retrieval image and the feature of the to-be-recognized image.

In the case that the feature similarity is greater than a predetermined threshold, it is able to determine that the object in the candidate retrieval image and the object in the to-be-recognized image are the same object, otherwise, they may be determined to be different objects. The predetermined threshold may be arranged in accordance with actual situation, the predetermined threshold may be different for different types of the candidate retrieval images, and the predetermined threshold should be larger when the appearance presentation label corresponding to the candidate retrieval image is more similar to the first appearance presentation information.

In the case that there is a plurality of candidate retrieval images, it is able to determine the feature similarity between the feature of each candidate retrieval image and the feature of the to-be-recognized image respectively, and determine whether the object in each candidate retrieval image and the object in the to-be-recognized image are the same object based on the feature similarity.

In this embodiment, through obtaining the to-be-recognized image, and the to-be-recognized image including the image content of the target object; recognizing the first appearance presentation information corresponding to the target object, and the first appearance presentation information being configured to represent the presentation form of the appearance of the target object in the to-be-recognized image; obtaining from the data retrieval library the candidate retrieval image matching the first appearance presentation information; and performing the target re-recognition on the to-be-recognized image based on the candidate retrieval image, it is able to align the two to-be-compared images as much as possible in the presentation form of the image content of the object, so as to reduce the interference of the presentation form of the image content of the object on the image content itself, thereby to improve the accuracy of target re-recognition.

In addition, through obtaining from the data retrieval library the candidate retrieval image matching the first appearance presentation information and performing the target re-recognition on the to-be-recognized image based on the candidate retrieval image, it is able to reduce the quantity of times of image comparisons, so as to improve the recognition efficiency of target re-recognition.

In addition, if the appearance presentation size of the target object represented by the first appearance presentation information is relatively small, or the appearance presentation truncation ratio of the target object represented by the first appearance presentation information is relatively large, in an implementation scenario, in order to ensure the quality of the retrieval images in the data retrieval library, the to-be-recognized image may be determined as a low-quality image, and no storing operation is to be performed. In another implementation scenario such as a security scenario, the predetermined threshold may be reduced when the feature similarity is compared to judge whether the objects in the two images are the same object, and then final judgment is made manually.

Optionally, the data retrieval library includes M retrieval images and K appearance presentation labels corresponding to the M retrieval images, each of the retrieval images corresponds to at least one of the appearance presentation labels, where M is a positive integer, and K is a positive integer greater than or equal to M. Step S103 specifically includes determining an appearance presentation similarity between the first appearance presentation information and each of the appearance presentation labels to obtain K appearance presentation similarities corresponding to the K appearance presentation labels respectively; and in the case that there is a target appearance presentation similarity in the K appearance presentation similarities that is greater than or equal to a first predetermined threshold, determining a retrieval image among the M retrieval images that corresponds to a target appearance presentation label as the candidate retrieval image, and the target appearance presentation label being an appearance presentation label among the K appearance presentation labels that corresponds to the target appearance presentation similarity.

In this embodiment, the data retrieval library may include M retrieval images, and each retrieval image includes the image content of at least one object. In this regard, each retrieval image may correspond to at least one appearance presentation label.

The appearance presentation similarity between the first appearance presentation information and each appearance presentation label may be determined, so as to determine whether the presentation form of the target object is consistent with the presentation form of each object in the data retrieval library.

The similarity between the appearance presentation label and the first appearance presentation information may be determined through calculating a distance between the appearance presentation label and the first appearance presentation information, i.e., the similarity is equal to 1 subtracts the distance.

The distance between the appearance presentation label and the first appearance presentation information may be calculated by a distance formula, to be specific, it is able to calculate through a distance formula a distance between the appearance presentation size and the appearance presentation size label, a distance between the appearance presentation posture and the appearance presentation posture label, a distance between the appearance presentation truncation ratio and the appearance presentation truncation ratio label, and a distance between the appearance truncation position and the appearance truncation position label. A sum of these distances, or an average value of these distances may be determined as the distance between the appearance presentation label and the first appearance presentation information.

In the case that there is a target appearance presentation similarity greater than or equal to the first predetermined threshold in the K appearance presentation similarities, it is determined that there is a candidate retrieval image matching the first appearance presentation information in the data retrieval library.

There are two types of candidate search images, wherein the first type of candidate retrieval image may be referred to as a first candidate retrieval image, which indicates a candidate retrieval image corresponding to a first target appearance presentation label, and the first target appearance presentation label indicates an appearance presentation label that is quite similar to the first appearance presentation information, i.e., the similarity between the first target appearance presentation label and the first appearance presentation information is greater than or equal to a sixth predetermined threshold, and the sixth predetermined threshold is generally larger, such as 90%. When it is determined that that there is a retrieval image corresponding to the first target appearance presentation label in the data retrieval library, the retrieval image corresponding to the first target appearance presentation label in the data retrieval library is obtained as the first candidate retrieval image.

The second type of candidate retrieval image may be referred to as a second candidate retrieval image, which indicates a candidate retrieval image corresponding to a second target appearance presentation label, and the second target appearance presentation label indicates an appearance presentation label that is relatively similar to the first appearance presentation information, i.e., the similarity between the second target appearance presentation label and the first appearance presentation information is greater than or equal to the first predetermined threshold and less than the sixth predetermined threshold. The sixth predetermined threshold is greater than the first predetermined threshold, and the first predetermined threshold may not be too small, otherwise, a retrieval image in which the presentation form of the object in the data retrieval library is inconsistent with the presentation form of the object in the to-be-recognized image may be taken as the candidate retrieval image, which adversely affects the accuracy of the target re-recognition. When it is determined that that there is a retrieval image corresponding to the second target appearance presentation label in the data retrieval library, the retrieval image corresponding to the second target appearance presentation label in the data retrieval library is obtained as the second candidate retrieval image.

It should be appreciated that, in the case that the candidate retrieval image includes the image content of a plurality of objects, and the appearance presentation similarity between each of the appearance presentation labels of at least two objects and the first appearance presentation information is greater than or equal to a first predetermined threshold, for the candidate retrieval image, the feature corresponding to the image content of each object in the candidate retrieval image may be compared with the feature corresponding to the image content of the target object in the to-be-recognized image respectively when subsequent image comparison is performed, so as to determine the relationship between each object in the candidate retrieval image and the target object.

In this embodiment, through determining the appearance presentation similarity between the first appearance presentation information and each of the appearance presentation labels to obtain K appearance presentation similarities corresponding to the K appearance presentation labels respectively; and in the case that there is a target appearance presentation similarity in the K appearance presentation similarities that is greater than or equal to a first predetermined threshold, determining a retrieval image among the M retrieval images that corresponds to a target appearance presentation label as the candidate retrieval image, and the target appearance presentation label being an appearance presentation label among the K appearance presentation labels that corresponds to the target appearance presentation similarity, it is able to improve the efficiency of image retrieval and improve recognition efficiency of target re-recognition.

Optionally, prior to step S103, the method further includes: obtaining a to-be-stored image and second appearance presentation information corresponding to the to-be-stored image; in the case that the second appearance presentation information meets a predetermined condition, determining identification information of an object in the to-be-stored image; and storing in a corresponding manner the to-be-stored image and the second appearance presentation information into the data retrieval library based on the identification information. The predetermined condition comprises at least one of: an appearance presentation size of an object represented by the second appearance presentation information being less than a second predetermined threshold, and an appearance presentation truncation ratio of the object represented by the second appearance presentation information being greater than a third predetermined threshold.

In this embodiment, a storing operation should be performed on the to-be-stored image before it is stored. In one aspect, the second appearance presentation information corresponding to the to-be-stored image is determined, so as to enable the second appearance presentation information to be stored in association with the to-be-stored image; and in another aspect, the quality of the to-be-stored image may be determined based on the second appearance presentation information, an image of low quality may be filtered out, and the image meeting the requirements may be used as the retrieval image in the data retrieval library, so as to implement the repeated retrieval for target re-recognition.

A method for obtaining the to-be-stored image may be similar to the method for obtaining the to-be-recognized image, which will not be further particularly defined herein.

In a possible embodiment of the present disclosure, as shown in FIG. 2, the appearance presentation size of the object in the to-be-stored image may be determined though a size discriminator, which may be a logic code for judging in accordance with the size of the image, or may be a model used to accurately judge the size and blur degree of the actual human body in the image. When the appearance presentation size of the object in the to-be-stored image is too small, the to-be-stored image may be determined as a low-quality image, the to-be-stored image is discarded directly, and no subsequent storing operation is to be performed.

The appearance truncation position and the appearance presentation truncation ratio of the target object in the to-be-stored image may be determined through the truncation discriminator. The truncation discriminator may be a pre-trained model for judging whether an object in an image is truncated and judging the truncated position of the appearance and the appearance presentation truncation ratio in response to the object being truncated. If it is determined that the appearance presentation truncation ratio exceeds a certain threshold, the to-be-stored image may be determined to be a low-quality image, the to-be-stored image is discarded directly, and no subsequent storing operation is to be performed.

The execution order of determining the second appearance presentation information corresponding to the to-be-stored image through the size discriminator and the truncation discriminator may not be limited, i.e., the appearance presentation size may be determined first, or the appearance presentation truncation ratio may be determined first, or both of the determinations may be performed simultaneously.

After that, the appearance orientation of the object in the to-be-recognized image may be determined through the orientation discriminator. The orientation discriminator may be a pre-trained model for judging an orientation of an object in an image, e.g., the orientation of the human body, is front, back, or a side.

In the case of determining the second appearance presentation information, if the presentation form of the object represented by the second appearance presentation information in the to-be-stored image meets the requirements, i.e., the appearance presentation size of the object represented by the second appearance presentation information is less than the second predetermined threshold and the appearance presentation truncation ratio of the object represented by the second appearance presentation information is greater than the third predetermined threshold, the identification information of the object in the to-be-stored image may be determined. The second predetermined threshold and the third predetermined threshold may be arranged in accordance with actual situation, which will not be particularly defined herein.

For example, when the object is a person, the identification information of the object in the to-be-stored image may refer to the identity information of the object, and the identity information of the object may be recognized through the re-recognition model.

As shown in FIG. 2, the re-recognition model may extract the feature of the retrieval image in the data retrieval library matching the second appearance presentation information and the feature of the to-be-stored image, and compare the features to determine the identity information of the object in the to-be-stored image. If there is no retrieval image matching the second appearance presentation information in the data retrieval library, a matching standard and the predetermined threshold may be reduced to compare the feature of the to-be-stored image with the feature of the retrieval image corresponding to another appearance presentation label in the data retrieval library, so as to determine the identity information of the object in the to-be-stored image.

The retrieval images in the data retrieval library may be organized and stored in accordance with the identities and the appearance presentation labels. For example, the retrieval images with the same identity may be stored in a folder, or retrieval images corresponding to similar appearance presentation labels may be stored in a folder. If the data retrieval library includes an object with the same identity as the object in the to-be-stored image, but does not include an image similar to the to-be-stored image, the image may be stored, and the image may also be archived into a corresponding sub-category such as a corresponding folder in accordance with the identity and appearance presentation label. If there is no object with the same identity as the object in the to-be-stored image in the data retrieval library, the object in the to-be-stored image may be identified with a new identity, and the to-be-stored image is stored.

In this embodiment, through obtaining the to-be-stored image and the second appearance presentation information corresponding to the to-be-stored image; in the case that the second appearance presentation information meets the predetermined condition, determining identification information of an object in the to-be-stored image; storing in a corresponding manner the to-be-stored image and the second appearance presentation information into the data retrieval library based on the identification information; and the predetermined condition including at least one of: the appearance presentation size of the object represented by the second appearance presentation information being less than the second predetermined threshold, and the appearance presentation truncation ratio of the object represented by the second appearance presentation information being greater than a third predetermined threshold, in one aspect, it is able to store the appearance presentation labels and the retrieval images in the data retrieval library in an associated manner, and in another aspect, it is able to ensure the quality of the retrieval images in the data retrieval library, so as to avoid adversely affecting recognition accuracy of the target re-recognition due to poor quality of the retrieved image and filter out low-quality images fundamentally, thereby to further improve the recognition accuracy of the target re-recognition.

Optionally, step 5104 specifically includes: performing feature extraction on the candidate retrieval image to obtain a first feature, and performing the feature extraction on the to-be-recognized image to obtain a second feature; determining a feature similarity between the first feature and the second feature; and determining a relationship between the target object and an object in the candidate retrieval image based on the feature similarity, and the relationship representing whether the target object and the object in the candidate retrieval image belong to a same object.

In this embodiment, through performing the feature extraction on the candidate retrieval image to obtain the first feature, and performing the feature extraction on the to-be-recognized image to obtain the second feature; determining the feature similarity between the first feature and the second feature; and determining the relationship between the target object and the object in the candidate retrieval image based on the feature similarity, and the relationship representing whether the target object and the object in the candidate retrieval image belong to a same object, it is able to achieve the target re-recognition of the to-be-recognized image.

Optionally, the determining the relationship between the target object and the object in the candidate retrieval image based on the feature similarity includes at least one of: in the case that the candidate retrieval image is a first candidate retrieval image, determining that the target object and the object in the candidate retrieval image belong to the same object in response to the feature similarity being greater than a fourth predetermined threshold; and in the case that the candidate retrieval image is a second candidate retrieval image, determining that the target object and the object in the candidate retrieval image belong to the same object in response to the feature similarity being greater than a fifth predetermined threshold. A target appearance presentation similarity corresponding to the first candidate retrieval image is greater than a target appearance presentation similarity corresponding to the second candidate retrieval image, the target appearance presentation similarity is an appearance presentation similarity between the first appearance presentation information and an appearance presentation label corresponding to the candidate retrieval image, and the fourth predetermined threshold is greater than the fifth predetermined threshold.

In this embodiment, the candidate retrieval image may include only the first candidate retrieval image. In this case, the feature similarity may be determined in accordance with a strict threshold, i.e., a relatively large threshold; only when the feature similarity is greater than the fourth predetermined threshold, it indicates that the first feature is similar to the second feature, and it is determined that the target object and the object in the candidate retrieval image belong to the same object.

Alternatively, the candidate retrieval image may include only the second candidate retrieval image. In this case, the feature similarity may be determined in accordance with a non-strict threshold, i.e., a threshold relatively less than the fourth predetermined threshold, the first feature is similar to the second feature when the feature similarity is greater than the fifth predetermined threshold, and it is determined that the target object and the object in the candidate retrieval image belong to the same object. In order to ensure the accuracy of the judgment result, in this case, the final judgment may further be made manually.

Alternatively, the candidate retrieval image may include both the first candidate retrieval image and the second candidate retrieval image at the same time. In this case, the feature similarity between the feature of the first candidate retrieval image and the feature of the to-be-recognized image may be determined in accordance with the strict threshold, and the feature similarity between the feature of the second candidate retrieval image and the feature of the to-be-recognized image may be determined in accordance with the non-strict threshold at the same time.

In this embodiment, different predetermined thresholds may be used to determine the feature similarity of the two images in accordance with the type of the candidate retrieval image, so as to ensure the recognition accuracy of the target re-recognition and reduce probability of missed detection of the target re-recognition.

### Second Embodiment

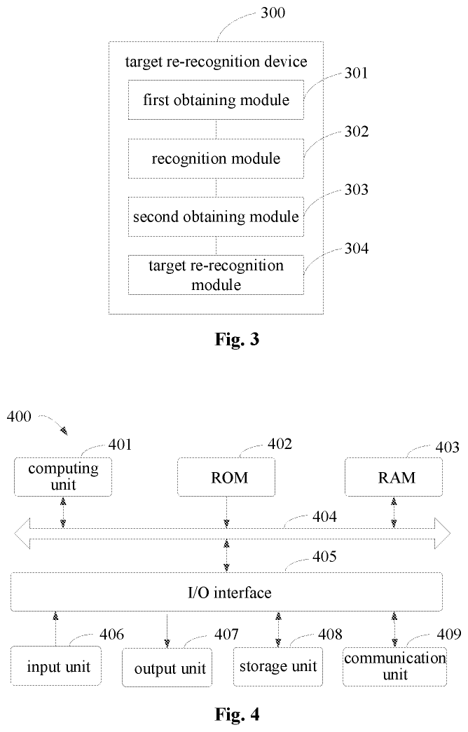

As shown in FIG. 3, the present disclosure provides a target re-recognition device 300, including: a first obtaining module 301, configured to obtain a to-be-recognized image, and the to-be-recognized image comprising image content of a target object; an recognition module 302, configured to recognize first appearance presentation information corresponding to the target object, and the first appearance presentation information being configured to represent a presentation form of an appearance of the target object in the to-be-recognized image; a second obtaining module 303, configured to obtain from a data retrieval library a candidate retrieval image matching the first appearance presentation information; and a target re-recognition module 304, configured to perform target re-recognition on the to-be-recognized image based on the candidate retrieval image.

Optionally, the data retrieval library includes M retrieval images and K appearance presentation labels corresponding to the M retrieval images, each of the retrieval images corresponds to at least one of the appearance presentation labels, where M is a positive integer, and K is a positive integer greater than or equal to M. The second obtaining module 303 is specifically configured to determine an appearance presentation similarity between the first appearance presentation information and each of the appearance presentation labels to obtain K appearance presentation similarities corresponding to the K appearance presentation labels respectively; and in the case that there is a target appearance presentation similarity in the K appearance presentation similarities that is greater than or equal to a first predetermined threshold, determine a retrieval image corresponding to a target appearance presentation label in the M retrieval images as the candidate retrieval image, and the target appearance presentation label being an appearance presentation label among the K appearance presentation labels that corresponds to the target appearance presentation similarity.

Optionally, the device further includes: a third obtaining module, configured to obtain a to-be-stored image and second appearance presentation information corresponding to the to-be-stored image; a determination module, configured to determine identification information of an object in the to-be-stored image in the case that the second appearance presentation information meets a predetermined condition; and a storage module, configured to store in a corresponding manner the to-be-stored image and the second appearance presentation information into the data retrieval library based on the identification information. The predetermined condition includes at least one of: an appearance presentation size of an object represented by the second appearance presentation information being less than a second predetermined threshold, and an appearance presentation truncation ratio of the object represented by the second appearance presentation information being greater than a third predetermined threshold.

Optionally, the target re-recognition module 304 includes: a feature extraction unit, configured to perform feature extraction on the candidate retrieval image to obtain a first feature, and perform the feature extraction on the to-be-recognized image to obtain a second feature; a first determination unit configured to determine a feature similarity between the first feature and the second feature; and a second determination unit, configured to determine a relationship between the target object and an object in the candidate retrieval image based on the feature similarity, and the relationship representing whether the target object and the object in the candidate retrieval image belong to a same object.

Optionally, the second determination unit is specifically configured to: in the case that the candidate retrieval image is a first candidate retrieval image, determine that the target object and the object in the candidate retrieval image belong to the same object in response to the feature similarity being greater than a fourth predetermined threshold; and in the case that the candidate retrieval image is a second candidate retrieval image, determine that the target object and the object in the candidate retrieval image belong to the same object in response to the feature similarity being greater than a fifth predetermined threshold. A target appearance presentation similarity corresponding to the first candidate retrieval image is greater than a target appearance presentation similarity corresponding to the second candidate retrieval image, the target appearance presentation similarity is an appearance presentation similarity between the first appearance presentation information and an appearance presentation label corresponding to the candidate retrieval image, and the fourth predetermined threshold is greater than the fifth predetermined threshold.

According to the embodiments of the present disclosure, the target re-recognition device 300 may implement the steps in the above-mentioned target re-recognition method with a same technical effect, which will not be particularly defined herein.

The target re-recognition device 300 in the embodiments of the present disclosure may achieve each process of the implementation of the target re-recognition method, and achieve the same beneficial effects, which will thus not be particularly defined herein.

According to the technical solutions in the embodiments of the present disclosure, the collection, storage, use, processing, transmission, provision and disclosure of user's personal information comply with provisions of relevant laws and regulations, and do not violate public order and good customs.

According to embodiments of the present disclosure, an electronic device, a readable storage medium and a computer program product are further provided.

FIG. 4 is a schematic block diagram of an exemplary electronic device 400 in which embodiments of the present disclosure may be implemented. The electronic device is intended to represent all kinds of digital computers, such as a laptop computer, a desktop computer, a work station, a personal digital assistant, a server, a blade server, a main frame or other suitable computers. The electronic device may also represent all kinds of mobile devices, such as a personal digital assistant, a cell phone, a smart phone, a wearable device and other similar computing devices. The components shown here, their connections and relationships, and their functions, are meant to be exemplary only, and are not meant to limit implementations of the present disclosure described and/or claimed herein.

As shown in FIG. 4, the device 400 includes a computing unit 401. The computing unit 401 may carry out various suitable actions and processes according to a computer program stored in a read-only memory (ROM) 402 or a computer program loaded from a storage unit 408 into a random access memory (RAM) 403. The RAM 403 may as well store therein all kinds of programs and data required for the operation of the device 400. The computing unit 401, the ROM 402 and the RAM 403 are connected to each other through a bus 404. An input/output (I/O) interface 405 is also connected to the bus 404.

Multiple components in the device 400 are connected to the I/O interface 405. The multiple components include: an input unit 406, e.g., a keyboard, a mouse and the like; an output unit 407, e.g., a variety of displays, loudspeakers, and the like; a storage unit 408, e.g., a magnetic disk, an optic disc and the like; and a communication unit 409, e.g., a network card, a modem, a wireless transceiver, and the like. The communication unit 409 allows the device 400 to exchange information/data with other devices through a computer network and/or other telecommunication networks, such as the Internet.

The computing unit 401 may be any general purpose and/or special purpose processing components having a processing and computing capability. Some examples of the computing unit 401 include, but are not limited to: a central processing unit (CPU), a graphic processing unit (GPU), various special purpose artificial intelligence (AI) computing chips, various computing units running a machine learning model algorithm, a digital signal processor (DSP), and any suitable processor, controller, microcontroller, etc. The computing unit 401 carries out the aforementioned methods and processes, e.g., the target re-recognition method. For example, in some embodiments, the target re-recognition method may be implemented as a computer software program tangibly embodied in a machine readable medium such as the storage unit 408. In some embodiments, all or a part of the computer program may be loaded and/or installed on the device 400 through the ROM 402 and/or the communication unit 409. When the computer program is loaded into the RAM 403 and executed by the computing unit 401, one or more steps of the foregoing target re-recognition method may be implemented. Optionally, in other embodiments, the computing unit 401 may be configured in any other suitable manner (e.g., by means of a firmware) to implement the target re-recognition method.

Various implementations of the aforementioned systems and techniques may be implemented in a digital electronic circuit system, an integrated circuit system, a field-programmable gate array (FPGA), an application specific integrated circuit (ASIC), an application specific standard product (ASSP), a system on a chip (SOC), a complex programmable logic device (CPLD), a computer hardware, a firmware, a software, and/or a combination thereof. The various implementations may include an implementation in form of one or more computer programs. The one or more computer programs may be executed and/or interpreted on a programmable system including at least one programmable processor. The programmable processor may be a special purpose or general purpose programmable processor, may receive data and instructions from a storage system, at least one input device and at least one output device, and may transmit data and instructions to the storage system, the at least one input device and the at least one output device.

Program codes for implementing the methods of the present disclosure may be written in one programming language or any combination of multiple programming languages. These program codes may be provided to a processor or controller of a general purpose computer, a special purpose computer, or other programmable data processing device, such that the functions/operations specified in the flow diagram and/or block diagram are implemented when the program codes are executed by the processor or controller. The program codes may be run entirely on a machine, run partially on the machine, run partially on the machine and partially on a remote machine as a standalone software package, or run entirely on the remote machine or server.

In the context of the present disclosure, the machine readable medium may be a tangible medium, and may include or store a program used by an instruction execution system, device or apparatus, or a program used in conjunction with the instruction execution system, device or apparatus. The machine readable medium may be a machine readable signal medium or a machine readable storage medium. The machine readable medium includes, but is not limited to: an electronic, magnetic, optical, electromagnetic, infrared, or semiconductor system, device or apparatus, or any suitable combination thereof. A more specific example of the machine readable storage medium includes: an electrical connection based on one or more wires, a portable computer disk, a hard disk, a random access memory (RAM), a read only memory (ROM), an erasable programmable read only memory (EPROM or flash memory), an optic fiber, a portable compact disc read only memory (CD-ROM), an optical storage device, a magnetic storage device, or any suitable combination thereof.

To facilitate user interaction, the system and technique described herein may be implemented on a computer. The computer is provided with a display device (for example, a cathode ray tube (CRT) or liquid crystal display (LCD) monitor) for displaying information to a user, a keyboard and a pointing device (for example, a mouse or a track ball). The user may provide an input to the computer through the keyboard and the pointing device. Other kinds of devices may be provided for user interaction, for example, a feedback provided to the user may be any manner of sensory feedback (e.g., visual feedback, auditory feedback, or tactile feedback); and input from the user may be received by any means (including sound input, voice input, or tactile input).

The system and technique described herein may be implemented in a computing system that includes a back-end component (e.g., as a data server), or that includes a middle-ware component (e.g., an application server), or that includes a front-end component (e.g., a client computer having a graphical user interface or a Web browser through which a user may interact with an implementation of the system and technique), or any combination of such back-end, middleware, or front-end components. The components of the system may be interconnected by any form or medium of digital data communication (e.g., a communication network). Examples of communication networks include a local area network (LAN), a wide area network (WAN) and the Internet.

The computer system may include a client and a server. The client and server are generally remote from each other and typically interact through a communication network. The relationship of client and server arises by virtue of computer programs running on respective computers and having a client-server relationship to each other. The server may be a cloud server, a server with a distributed system, or a server combined with a block chain.

It is appreciated, all forms of processes shown above may be used, and steps thereof may be reordered, added or deleted. For example, as long as expected results of the technical solutions of the present disclosure may be achieved, steps set forth in the present disclosure may be performed in parallel, performed sequentially, or performed in a different order, and there is no limitation in this regard.

The foregoing specific implementations constitute no limitation on the scope of the present disclosure. It is appreciated by those skilled in the art, various modifications, combinations, sub-combinations and replacements may be made according to design requirements and other factors. Any modifications, equivalent replacements and improvements made without deviating from the spirit and principle of the present disclosure shall be deemed as falling within the scope of the present disclosure.

What is claimed is:

1. A target re-recognition method, comprising:
obtaining a to-be-recognized image, and the to-be-recognized image comprising image content of a target object;
recognizing first appearance presentation information corresponding to the target object, and the first appearance presentation information being configured to represent a presentation form of an appearance of the target object in the to-be-recognized image;
obtaining from a data retrieval library a candidate retrieval image matching the first appearance presentation information; and
performing target re-recognition on the to-be-recognized image based on the candidate retrieval image.

2. The target re-recognition method according to claim 1, wherein the data retrieval library comprises M retrieval images and K appearance presentation labels corresponding to the M retrieval images, each of the retrieval images corresponds to at least one of the appearance presentation labels, where M is a positive integer, and K is a positive integer greater than or equal to M; and the obtaining from the data retrieval library the candidate retrieval image matching the first appearance presentation information comprises:
determining an appearance presentation similarity between the first appearance presentation information and each of the appearance presentation labels, to obtain K appearance presentation similarities corresponding to the K appearance presentation labels respectively; and
in the case that there is a target appearance presentation similarity in the K appearance presentation similarities that is greater than or equal to a first predetermined threshold, determining a retrieval image among the M retrieval images that corresponds to a target appearance presentation label as the candidate retrieval image, and the target appearance presentation label being an appearance presentation label among the K appearance presentation labels that corresponds to the target appearance presentation similarity.

3. The target re-recognition method according to claim 2, wherein prior to obtaining from the data retrieval library the candidate retrieval image matching the first appearance presentation information, the target re-recognition method further comprises:
obtaining a to-be-stored image and second appearance presentation information corresponding to the to-be-stored image;
in the case that the second appearance presentation information meets a predetermined condition, determining identification information of an object in the to-be-stored image; and
storing in a corresponding manner the to-be-stored image and the second appearance presentation information into the data retrieval library based on the identification information;
wherein the predetermined condition comprises at least one of:
an appearance presentation size of an object represented by the second appearance presentation information being less than a second predetermined threshold;
an appearance presentation truncation ratio of the object represented by the second appearance presentation information being greater than a third predetermined threshold.

4. The target re-recognition method according to claim 1, wherein the performing the target re-recognition on the to-be-recognized image based on the candidate retrieval image comprises:
performing feature extraction on the candidate retrieval image to obtain a first feature, and performing the feature extraction on the to-be-recognized image to obtain a second feature;
determining a feature similarity between the first feature and the second feature;
determining a relationship between the target object and an object in the candidate retrieval image based on the feature similarity, and the relationship representing whether the target object and the object in the candidate retrieval image belong to a same object.

5. The target re-recognition method according to claim 4, wherein the determining the relationship between the target object and the object in the candidate retrieval image based on the feature similarity comprises at least one of:
in the case that the candidate retrieval image is a first candidate retrieval image, determining that the target object and the object in the candidate retrieval image belong to the same object in response to the feature similarity being greater than a fourth predetermined threshold; and
in the case that the candidate retrieval image is a second candidate retrieval image, determining that the target object and the object in the candidate retrieval image belong to the same object in response to the feature similarity being greater than a fifth predetermined threshold; wherein
a target appearance presentation similarity corresponding to the first candidate retrieval image is greater than a target appearance presentation similarity corresponding to the second candidate retrieval image, the target appearance presentation similarity is an appearance presentation similarity between the first appearance presentation information and an appearance presentation label corresponding to the candidate retrieval image, and the fourth predetermined threshold is greater than the fifth predetermined threshold.

6. An electronic device, comprising:
at least one processor; and
a storage communicatively connected to the at least one processor,
wherein the storage stores therein an instruction configured to be executed by the at least one processor, and the at least one processor is configured to execute the instruction, to implement a target re-recognition method comprising:
obtaining a to-be-recognized image, and the to-be-recognized image comprising image content of a target object;
recognizing first appearance presentation information corresponding to the target object, and the first appearance presentation information being configured to represent a presentation form of an appearance of the target object in the to-be-recognized image;
obtaining from a data retrieval library a candidate retrieval image matching the first appearance presentation information; and
performing target re-recognition on the to-be-recognized image based on the candidate retrieval image.

7. The electronic device according to claim 6, wherein the data retrieval library comprises M retrieval images and K appearance presentation labels corresponding to the M retrieval images, each of the retrieval images corresponds to at least one of the appearance presentation labels, where M is a positive integer, and K is a positive integer greater than or equal to M; and the obtaining from the data retrieval library the candidate retrieval image matching the first appearance presentation information comprises:
determining an appearance presentation similarity between the first appearance presentation information and each of the appearance presentation labels, to obtain K appearance presentation similarities corresponding to the K appearance presentation labels respectively; and
in the case that there is a target appearance presentation similarity in the K appearance presentation similarities that is greater than or equal to a first predetermined threshold, determining a retrieval image among the M retrieval images that corresponds to a target appearance presentation label as the candidate retrieval image, and the target appearance presentation label being an appearance presentation label among the K appearance presentation labels that corresponds to the target appearance presentation similarity.

8. The electronic device according to claim 7, wherein the at least one processor is configured to execute the instruction to: prior to obtaining from the data retrieval library the candidate retrieval image matching the first appearance presentation information,
obtain a to-be-stored image and second appearance presentation information corresponding to the to-be-stored image;
in the case that the second appearance presentation information meets a predetermined condition, determine identification information of an object in the to-be-stored image; and
store in a corresponding manner the to-be-stored image and the second appearance presentation information into the data retrieval library based on the identification information;
wherein the predetermined condition comprises at least one of:
an appearance presentation size of an object represented by the second appearance presentation information being less than a second predetermined threshold;
an appearance presentation truncation ratio of the object represented by the second appearance presentation information being greater than a third predetermined threshold.

9. The electronic device according to claim 6, wherein the performing the target re-recognition on the to-be-recognized image based on the candidate retrieval image comprises:
performing feature extraction on the candidate retrieval image to obtain a first feature, and performing the feature extraction on the to-be-recognized image to obtain a second feature;
determining a feature similarity between the first feature and the second feature;
determining a relationship between the target object and an object in the candidate retrieval image based on the feature similarity, and the relationship representing whether the target object and the object in the candidate retrieval image belong to a same object.

10. The electronic device according to claim 9, wherein the determining the relationship between the target object and the object in the candidate retrieval image based on the feature similarity comprises at least one of:
in the case that the candidate retrieval image is a first candidate retrieval image, determining that the target object and the object in the candidate retrieval image belong to the same object in response to the feature similarity being greater than a fourth predetermined threshold; and
in the case that the candidate retrieval image is a second candidate retrieval image, determining that the target object and the object in the candidate retrieval image belong to the same object in response to the feature similarity being greater than a fifth predetermined threshold; wherein
a target appearance presentation similarity corresponding to the first candidate retrieval image is greater than a target appearance presentation similarity corresponding to the second candidate retrieval image, the target appearance presentation similarity is an appearance presentation similarity between the first appearance presentation information and an appearance presentation label corresponding to the candidate retrieval image, and the fourth predetermined threshold is greater than the fifth predetermined threshold.

11. A non-transitory computer readable storage medium, storing therein a computer instruction, wherein the computer instruction is configured to be executed by a computer, to implement a target re-recognition method comprising:
obtaining a to-be-recognized image, and the to-be-recognized image comprising image content of a target object;
recognizing first appearance presentation information corresponding to the target object, and the first appearance presentation information being configured to represent a presentation form of an appearance of the target object in the to-be-recognized image;
obtaining from a data retrieval library a candidate retrieval image matching the first appearance presentation information; and
performing target re-recognition on the to-be-recognized image based on the candidate retrieval image.

12. The non-transitory computer readable storage medium according to claim 11, wherein the data retrieval library comprises M retrieval images and K appearance presentation labels corresponding to the M retrieval images, each of the retrieval images corresponds to at least one of the appearance presentation labels, where M is a positive integer, and K is a positive integer greater than or equal to M; and the obtaining from the data retrieval library the candidate retrieval image matching the first appearance presentation information comprises:
determining an appearance presentation similarity between the first appearance presentation information and each of the appearance presentation labels, to obtain K appearance presentation similarities corresponding to the K appearance presentation labels respectively; and
in the case that there is a target appearance presentation similarity in the K appearance presentation similarities that is greater than or equal to a first predetermined threshold, determining a retrieval image among the M retrieval images that corresponds to a target appearance presentation label as the candidate retrieval image, and the target appearance presentation label being an appearance presentation label among the K appearance presentation labels that corresponds to the target appearance presentation similarity.

13. The non-transitory computer readable storage medium according to claim 12, wherein the computer instruction is configured to be executed by the computer to:
prior to obtaining from the data retrieval library the candidate retrieval image matching the first appearance presentation information,
obtain a to-be-stored image and second appearance presentation information corresponding to the to-be-stored image;
in the case that the second appearance presentation information meets a predetermined condition, determine identification information of an object in the to-be-stored image; and
store in a corresponding manner the to-be-stored image and the second appearance presentation information into the data retrieval library based on the identification information;
wherein the predetermined condition comprises at least one of:
an appearance presentation size of an object represented by the second appearance presentation information being less than a second predetermined threshold;
an appearance presentation truncation ratio of the object represented by the second appearance presentation information being greater than a third predetermined threshold.

14. The non-transitory computer readable storage medium according to claim 11, wherein the performing the target re-recognition on the to-be-recognized image based on the candidate retrieval image comprises:
performing feature extraction on the candidate retrieval image to obtain a first feature, and performing the feature extraction on the to-be-recognized image to obtain a second feature;
determining a feature similarity between the first feature and the second feature;
determining a relationship between the target object and an object in the candidate retrieval image based on the feature similarity, and the relationship representing whether the target object and the object in the candidate retrieval image belong to a same object.

15. The non-transitory computer readable storage medium according to claim 14, wherein the determining the relationship between the target object and the object in the candidate retrieval image based on the feature similarity comprises at least one of:
in the case that the candidate retrieval image is a first candidate retrieval image, determining that the target object and the object in the candidate retrieval image belong to the same object in response to the feature similarity being greater than a fourth predetermined threshold; and
in the case that the candidate retrieval image is a second candidate retrieval image, determining that the target object and the object in the candidate retrieval image belong to the same object in response to the feature similarity being greater than a fifth predetermined threshold; wherein
a target appearance presentation similarity corresponding to the first candidate retrieval image is greater than a target appearance presentation similarity corresponding to the second candidate retrieval image, the target appearance presentation similarity is an appearance presentation similarity between the first appearance presentation information and an appearance presentation label corresponding to the candidate retrieval image, and the fourth predetermined threshold is greater than the fifth predetermined threshold.

16. A computer program product comprising a computer program, wherein the computer program is configured to be executed by a processor, to implement the target re-recognition method according to claim 1.

17. The computer program product according to claim 16, wherein the data retrieval library comprises M retrieval images and K appearance presentation labels corresponding to the M retrieval images, each of the retrieval images corresponds to at least one of the appearance presentation labels, where M is a positive integer, and K is a positive integer greater than or equal to M; and the obtaining from the data retrieval library the candidate retrieval image matching the first appearance presentation information comprises:
determining an appearance presentation similarity between the first appearance presentation information and each of the appearance presentation labels, to obtain K appearance presentation similarities corresponding to the K appearance presentation labels respectively; and
in the case that there is a target appearance presentation similarity in the K appearance presentation similarities that is greater than or equal to a first predetermined threshold, determining a retrieval image among the M retrieval images that corresponds to a target appearance presentation label as the candidate retrieval image, and the target appearance presentation label being an appearance presentation label among the K appearance presentation labels that corresponds to the target appearance presentation similarity.

18. The computer program product according to claim 17, wherein the computer program is configured to be executed by the processor to: prior to obtaining from the data retrieval library the candidate retrieval image matching the first appearance presentation information,
obtain a to-be-stored image and second appearance presentation information corresponding to the to-be-stored image;
in the case that the second appearance presentation information meets a predetermined condition, determine identification information of an object in the to-be-stored image; and
store in a corresponding manner the to-be-stored image and the second appearance presentation information into the data retrieval library based on the identification information;
wherein the predetermined condition comprises at least one of:
an appearance presentation size of an object represented by the second appearance presentation information being less than a second predetermined threshold;
an appearance presentation truncation ratio of the object represented by the second appearance presentation information being greater than a third predetermined threshold.

19. The computer program product according to claim 16, wherein the performing the target re-recognition on the to-be-recognized image based on the candidate retrieval image comprises:
performing feature extraction on the candidate retrieval image to obtain a first feature, and performing the feature extraction on the to-be-recognized image to obtain a second feature;
determining a feature similarity between the first feature and the second feature;
determining a relationship between the target object and an object in the candidate retrieval image based on the feature similarity, and the relationship representing whether the target object and the object in the candidate retrieval image belong to a same object.

20. The computer program product according to claim 19, wherein the determining the relationship between the target object and the object in the candidate retrieval image based on the feature similarity comprises at least one of:
in the case that the candidate retrieval image is a first candidate retrieval image, determining that the target object and the object in the candidate retrieval image belong to the same object in response to the feature similarity being greater than a fourth predetermined threshold; and
in the case that the candidate retrieval image is a second candidate retrieval image, determining that the target object and the object in the candidate retrieval image belong to the same object in response to the feature similarity being greater than a fifth predetermined threshold; wherein
a target appearance presentation similarity corresponding to the first candidate retrieval image is greater than a target appearance presentation similarity corresponding to the second candidate retrieval image, the target appearance presentation similarity is an appearance presentation similarity between the first appearance presentation information and an appearance presentation label corresponding to the candidate retrieval image, and the fourth predetermined threshold is greater than the fifth predetermined threshold.
